(19) United States
(12) Patent Application Publication
(10) Pub. No.: US 2006/0188247 A1
(43) Pub. Date: Aug. 24, 2006

(54) Image pick up device comprising at least a code

(76) Inventor: Sjoerd Gerard Vrijburg, Rotterdam (NL)

Correspondence Address: Thomas Lizzi;IP & Internet Law North, Po Box 38, Zelienople, PA, 16063, US

(21) Appl. No.: 10/511,011

(22) PCT Filed: Apr. 9, 2003
(86) PCT No.: PCT/NL03/00268

§ 371 Date: Jun. 23, 2005

(30) Foreign Application Priority Data
Apr. 12, 2002 (NL) 1020376

(51) Int. Cl. G03B 19/00

(52) U.S. Cl. 396/429

(57) ABSTRACT

The present invention relates to an image pick-up device (1), comprising: —a housing, —image storage means, which are arranged in the housing for storing image data, —a first code (12), which is associated with the image storage means for identification thereof, —a second code (13) for locating the image data in a database. The image pick-up device is preferably suitable for once-only use.

The present invention relates to the field of photo cameras for once-only use, and to a system for making photos available. Photos are generally taken with the object of making it possible to bring back memories of a particular moment at a later time. A photo camera or image pick-up device is necessary to take photos. A print can further be made in order to view a photo.

In amusement parks or during large events, a photo service is often provided by the organiser. Such a photo service often entails the organiser taking and printing photos, and offering these prints for sale to interested parties at a stand. Such service is highly appreciated by the public. However, since the photos are not taken by the general public itself, they cannot influence the content of the photos.

The present invention provides a device which obviates the above stated drawback, among others. For this purpose the present invention provides an image pick-up device, comprising:
a housing,
image storage means which are arranged in the housing for storing image data,
a first code which is associated with the image storage means for identification thereof,
a second code for locating the image data in a database.

One advantage of the present invention becomes apparent when such image pick-up devices are made available to members of the public by for instance an amusement park or an event, so that they themselves can record images. After recording of the images the image pick-up device for once-only use can be turned in to the organiser, whereafter images can be made available to the maker thereof. The first and the second code serve to identify the images and the maker of the images, so as to be able to ensure that the correct maker receives the correct images. The image pick-up device is preferably suitable for once-only use.

The first code is preferably associated with the image storage means. If the image storage means comprise a photographic film and this is associated with the first code, it is possible to scan the image data, to store the data in the database and associate the data with the code.

In a further preferred embodiment the first code is associated with the housing. In the case of image pick-up devices for once-only use, a part of the function of the housing is the same as the function of the housing of a roll of film, i.e. to shield the light-sensitive film material from the outside world. In such a case the coupling between the first code and the image information recorded on the film material is adequately linked to the first code by arranging the first code on the housing.

In the context of the invention an image pick-up device for once-only use is defined in that the person making the images or photos obtains the camera and hands it in again after taking the photos. It is however very well possible for the camera or parts thereof to be re-used, whereby a subsequent person obtains this camera or parts thereof as image pick-up device for once-only use. It is also possible for the camera to be destroyed after use.

In a particular preferred embodiment the second code is arranged on coding means such as a label which is adhered releasably to the housing. By means of removing a label according to the present embodiment the person taking the photos removes the code from the housing. The person hereby obtains the code which the person can use at a later stage to gain access to the photos. One option for obtaining access to the photos is to input the code in a computer, using which the correct images can be retrieved from a data bank. This can for instance take place within an internet site, using internet.

In a further preferred embodiment the image storage means comprise digital storage means, and the image pick-up device further comprises digital image pick-up means for recording image information. Depending on cost-related developments in the electronics industry, it will sooner or later become possible to manufacture image pick-up devices for once-only use in cost-effective manner, wherein such image pick-up devices can be applied in a device according to the present invention.

A further aspect of the present invention provides a system for making images available, comprising:
at least one first computer for inputting a second code and viewing the images,
at least one second computer with at least one database for storing the images,
at least one computer network for connecting the computers, wherein:
the images are associated with a first code and the first code is the same as the second code or the second code is associated with the first code.

Such a system has the advantage that a person who knows that images are associated with a first code can retrieve from a databank via a computer network by making use of this code or a second code associated with the first code. It is possible here that the person took these photos him/herself or the person knows that the photos exist and has gained access to a code for searching for the photos.

In a further embodiment, for the purpose of taking the photos which are made available to a person by means of this system, these photos are taken using an image pick-up device for once-only use as according to the foregoing, wherein the first code and the second code of the image pick-up device correspond with the first code and the second code in the databank.

According to this embodiment a person obtains an image pick-up device or photo camera which is provided with a first code which identifies the recorded images by means of the first code which is arranged on the housing or in the image storage means. The image information of the images or photos is then stored in a database from which the person can retrieve the images using the first and/or second code. An advantage of such a system is that image material is only available to those having the retrieval code. A further advantage, which is for instance important in the above stated example of the amusement park or the event, is that the person can him/herself determine what the content of the images will be.

According to a further embodiment the first code is a field in the database. This field can for instance be used as key field for searching for the images.

The second code preferably comprises an internet address. It is advantageous if use is made of the internet to retrieve the images. This is for instance important because a growing part of the population has access to the internet and this allows a very user-friendly information access system, for instance by making use of generally used internet browser technology. A practical development hereof is for instance that the first code is a unique numeric code and the second code comprises an internet URL and the same numeric code. Alphanumeric codes or mixed codes are for instance also possible.

At least one part of the second code can preferably be searched for in a field in a database. If in this case a part of the second code is the same as the first code, then it is possible in relatively simple manner to link both codes and, making use hereof, to make image material searchable and/or retrievable.

According to a further embodiment the person can order photo prints with the images via the internet site. Photos or images made using film material generally have a very high resolution. Photos with such a high resolution are generally not done full justice when displayed on a screen which has a much lower resolution. There is further often a need to take prints of images to be viewed or shown at locations where no computer is available. Making use of the present embodiment it therefore becomes possible for the person to obtain a physical photo print on for instance paper. Use can be made herein of the full resolution of the original film material.

A further aspect of the present invention provides a method for distributing images, comprising steps for:
recording image data in image storage means of an image pick-up device for once-only use, which data are associated with a first code for identification of the image data,
removing or taking over a second code from the housing,
transferring the image data from the image storage means to a database together with the first code with which the image data are associated,
making a connection to the database using a computer and retrieving the image data on the basis of a second code, wherein:
the images are associated with the first code and the first code is the same as the second code or the second code is associated with the first code.

Advantages as specified in the foregoing likewise relate to this method. According to the present invention it becomes possible in very simple manner to obtain self-made images or photos in either digital or printed form by making use of the association between the two codes, wherein the person taking the photos obtains the code for gaining access to the image information from the housing of the image pick-up device.

Further advantages, features and details of the present invention will be elucidated on the basis of preferred embodiments which are shown in the appended figures, in which:

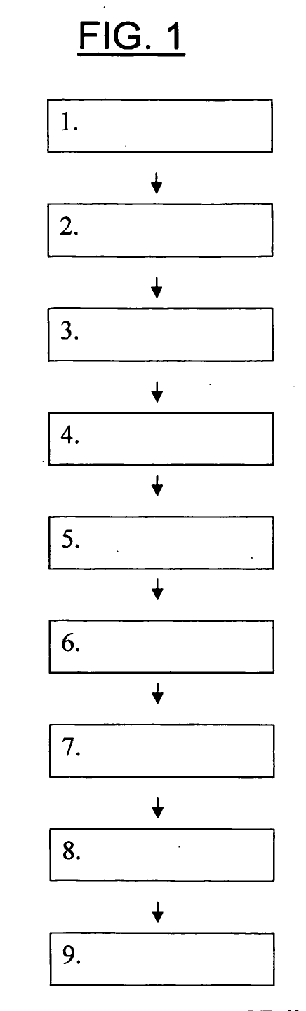

FIG. 1 is a flow diagram of a method according to the present invention,

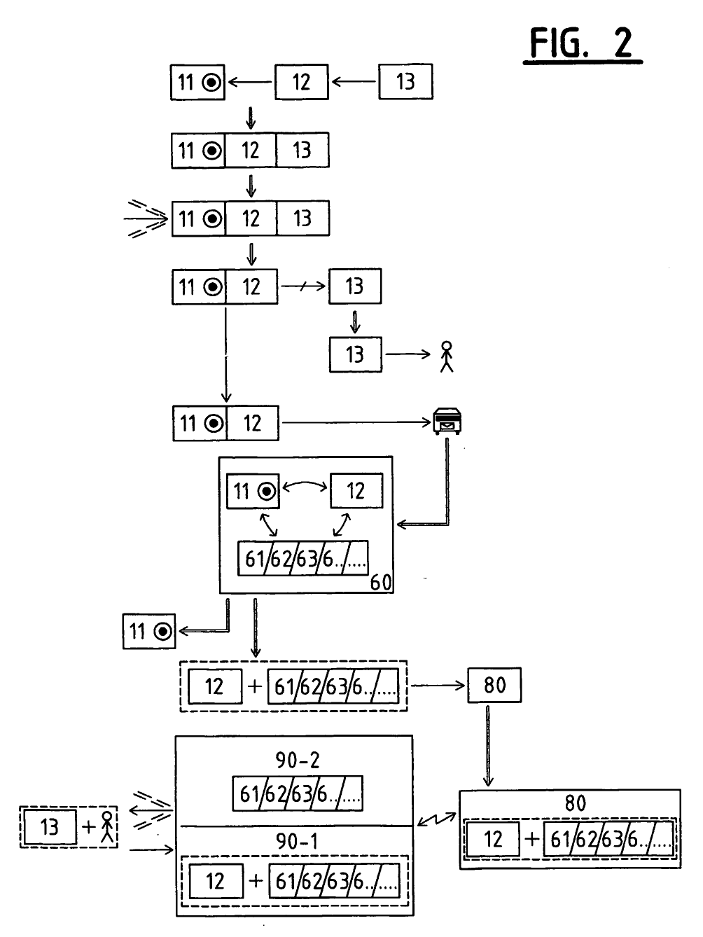

FIG. 2 is a block diagram of further embodiments according to the present invention.

In a preferred embodiment according to the present invention (FIG. 1) a disposable camera is linked to a code in step 1. The code is herein arranged for instance on a housing of a disposable camera (camera for once-only use). It is further possible for the code to be arranged on the recording medium such as a light-sensitive film or a digital memory. In this step of the method an optional second code is further arranged on the camera. This second code can be the same as the first but comprises at least one address of a server which can for instance be accessed via internet. The first and second code comprise in this case an internet address which can for instance consist of numbers and/or letters. An object of the method is that a person who has taken photos using the camera can view these by making contact with the server. It hereby becomes possible that the person who obtains such a disposable camera can obtain the photos and for instance show them to others in simple manner by using the code of the camera to gain access to the photos placed on the server.

A particular aspect is that the second code can be removed from the camera and used as an aid in remembering the code and/or the internet address.

In step 2 the camera provided with the code is distributed to the person who wants to take photos. A person often arrives at an event location or is in an amusement park and has no camera with him/her. In such a case a camera provided with codes as according to the present invention is made available to the person. After the photos have been taken (step 3), the camera is handed in, wherein the person retains or remembers the second code. He removes for instance a tear-off strip with the code from the camera (step 4) or he retains the package on which the code is arranged. Retaining of the code by the person who has taken and wants to view the photos is step 5. An alternative herefor is that a first code is arranged on the camera after the photos are taken, for instance when the camera is handed in. At this moment the person obtains a second code with which he gains access to the photos. As alternative to the tear-off strip, it is possible to envisage a sticker, a part which can be removed from the camera, the packaging of the camera, the housing of the camera, or writing down or remembering a code printed on the camera. It is further possible for instance to supply, along with a camera, an envelope on which the first code is arranged, and a second code is arranged on a tear-off strip which can be retained by the person after the camera has been sent off or handed in.

The camera with at least the first code is further returned from the person to a developing organization which places the photos in the databank in which they are associated with the first and second code. For this purpose the camera can be provided with a postal address and the camera can be deposited in a postbox. It is further possible that the camera is centrally collected and further processed during an event at which it is handed out.

The film is developed in the case of an analog camera, or the memory is read (step 6). After a time the photos are made available via the internet (step 8) and access to the photos can be gained on the basis of the (second) code (step 9). This period of time can vary from several days to even a few minutes after the film is developed or a digital memory is read.

In step 9 the person who has taken the photos and/or a third party who has obtained the code from the person gains access by means of an apparatus which provides Internet access. It is possible to envisage here a variety of devices suitable for this purpose, such as a PC, settop box, mobile telephone, game-playing device, palmtop computer and so on.

FIG. 2 shows schematically a system for taking photos and obtaining thereof according to the present invention. A camera for once-only use is provided with a first code 12 and a second code 13. The first code herein serves to identify an image memory member such as a light-sensitive film or a digital memory. The second code 13 preferably comprises an internet address or URL. The second code preferably further comprises (a part of) the first code for locating the photos of the film in a database 80. This is important for the person taking the photos being able to gain access to the photos on the basis of the code.

The first code is assembled in a known manner, for instance alphanumerically or in the form of a bar code. The second code 13 is shown on the camera or the packaging thereof in a manner readable by the person and inputtable into the computer. It is herein recommended that the second code can be removed from the camera such that the person removes and retains the code before he/she hands in the camera for developing and inputting of the photos into the computer. The second code can for instance be fixed to the camera by means of a releasable sticker or by means of a tear-off strip. The second code can also be arranged on the packaging of the camera. If the film in the camera is provided with a coding which can be used as first code, it may for instance be practical to provide the packaging with a different code, which can be used as second code, and to then link these codes to each other in the database so that the connection between the first code and the second code is suitable for gaining access to the photos when they are stored in the database and are linked to the codes, for instance in that they are all stored in a record.

The application of a first and a second code on a camera for once-only use hereby provides simple access to digitized photos. Prints of the photos can further be ordered. Low-resolution representations of the photos can be shown in known manner via the internet, wherein high-resolution prints or downloads can be made available under determined conditions, likewise in known manner.

FIG. 2 further shows how the person taking the photos with the camera removes the second code 13 from the camera or retains the packaging with the code, before sending the camera with the first code, after the photos have been taken, to a developing and digitizing station 60 via a transport system such as the post or a hand-in point. The films are here taken out of camera 11 with the code 12 and developed, and photos 61,62,63 . . . are digitized, wherein an association is created between the digitized photos and the code 12.

Depending on a specific embodiment of camera 11, it can be fully or partially re-used.

Data comprising code 12 and image data of the photos are stored in database 80. It is herein possible to store the image data in a high resolution or in both a high and a low resolution, or only in a low resolution. This depends on the desired form of use of the images at a later stage. If the images only have to be retrieved via a screen, a lower resolution suffices than when high-quality prints are required. One consideration in respect of storing images with a high resolution as well as images with a low resolution is to save computing capacity of the server when retrieving low-resolution images, which computing capacity is required to create low-resolution images on the basis of the high-resolution images.

Using an apparatus for gaining internet access 90-1 the person can then make contact with the server with the database 80 with data 12,61,62,63 . . . stored therein, this on the basis of the second code 13 which he has retained or optionally remembered. The data 12,61,62,63 . . . are herein transmitted from the server to apparatus 90-1. As specified, this apparatus can be a PC, mobile telephone, palmtop computer, game-playing device and so on. The images or photos are then shown on a display screen 90-2.

It is further possible to obtain the photos as prints. In that case the images are printed and for instance sent by post to the person or a further person who has obtained code 13 for this purpose.

The present embodiment is not limited to the above described embodiments. Many variations hereof can be applied within the concept of the invention. The rights sought are described in the appended claims.

1-19. (canceled)

20. A system for making available, via a wide area computer network, at least one image that is made by means of an image pick-up device having a housing, an image storing means arranged in the housing for storing image data, a first code which is associated with the image storage means for identification thereof, and a database locator code for locating the image data in a database, the system comprising:
(a) at least one first computer that is connectable to said computer network for inputting the database locator code and viewing the image; and
(b) at least one second computer that is connectable to said computer network having at least one database for storing the image and an image data transfer means for transferring the image data into the database;
wherein the image is associated with the first code and the first code is the same as the database locator code or the second code is associated with the first code.

21. The system of claim 20, wherein the first code is a field in the database.

22. The system of claim 20, wherein the database locator code comprises an internet address.

23. The system of claim 20, wherein at least one part of the database locator code can be searched for in a field in the database.

24. The system of claim 20, wherein the database is accessible via an internet site.

25. The system of claim 24, wherein a person can download the image from the second computer to the first computer via the internet site.

26. The system of claim 24, wherein a person can order a photo print of the image via the internet site.

27. The system of claim 20, wherein a part of the first code comprises an internet address.

28. The system of claim 20, comprising at least one image pick-up device, wherein the first code and the database locator code of the image pick-up device correspond with the first code in the database.

29. The system of claim 28, wherein the database locator code comprises an internet address.

30. The system of claim 28, wherein at least one part of the database locator code can be searched for in a field in the database.

31. The system of claim 28, wherein the database is accessible via an internet site.

32. The system of claim 31, wherein a person can download the image from the second computer to the first computer via the internet site.

33. The system of claim 31, wherein a person can order a photo print of the image via the internet site.

34. The system of claim 28, wherein a part of the first code comprises an internet address.

35. The system of claim 28, wherein the first code is a field in the database.

36. The system of claim 35, wherein at least one part of the database locator code can be searched for in a field in the database.

37. The system of claim 35, wherein the database is accessible via an internet site.

38. The system of claim 37, wherein a person can download the image from the second computer to the first computer via the internet site.

39. The system of claim 37, wherein a person can order a photo print of the image via the internet site.

40. The system of claim 35, wherein a part of the first code comprises an internet address.

41. The system of claim 35, wherein the database locator code comprises an internet address.

42. The system of claim 41, wherein the database is accessible via an internet site.

43. The system of claim 42, wherein a person can download the image from the second computer to the first computer via the internet site.

44. The system of claim 42, wherein a person can order a photo print of the image via the internet site.

45. The system of claim 41, wherein a part of the first code comprises an internet address.

46. The system of claim 41, wherein at least one part of the database locator code can be searched for in a field in the database.

47. The system of claim 46, wherein the database is accessible via an internet site.

48. The system of claim 47, wherein a person can download the image from the second computer to the first computer via the internet site.

49. The system of the claim 47, wherein a person can order a photo print of the image via the internet site.

50. The system of claim 47, wherein a part of the first code comprises an internet address.

51. The system of claim 47, wherein a person can download the image from the second computer to the first computer via the internet site.

52. A single use image pick-up device, comprising:
(a) a housing;
(b) an image storage means arranged in the housing for storing image data;
(c) a database;
(d) a first identification code for identifying the image storage means or a recorded image within the database, said first identification code being associated with the image storage means; and
(e) a database locator code for locating the database on a wide area computer network.

53. The image pick-up device of claim 52, wherein the first code is associated with the housing.

54. The image pick-up device of claim 52, wherein the database locator code is arranged on a coding means.

55. The image pick-up device of claim 54, wherein the coding means comprises a label which is adhered releasably to the housing.

56. The image pick-up device of claim 52, wherein the database locator code is arranged on a packaging of the image pick-up device.

57. The image pick-up device of claim 52, wherein the image storage means comprises a photographic film.

58. The image pick-up device of claim 52, wherein the image storage means comprises a digital storage means and the image pick-up device further comprises a digital image pick-up means for recording image information.

59. The image pick-up device as claimed in claim 52, wherein the first code is associated with the image storage means.

60. The image pick-up device of claim 59, wherein the database locator code is arranged on a coding means.

61. The image pick-up device of claim 60, wherein the coding means comprises a label which is adhered releasably to the housing.

62. The image pick-up device of claim 59, wherein the database locator code is arranged on a packaging of the image pick-up device.

63. The image pick-up device of claim 59, wherein the image storage means comprises a photographic film.

64. The image pick-up device of claim 59, wherein the image storage means comprises a digital storage means and the image pick-up device further comprises a digital image pick-up means for recording image information.

65. The image pick-up device of claim 59, wherein the first code is associated with the housing.

66. The image pick-up device of claim 65, wherein the database locator code is arranged on a packaging of the image pick-up device.

67. The image pick-up device of claim 65, wherein the image storage means comprises a photographic film.

68. The image pick-up device of claim 65, wherein the image storage means comprises a digital storage means and the image pick-up device further comprises a digital image pick-up means for recording image information.

69. The image pick-up device of claim 65, wherein the database locator code is arranged on a coding means.

70. The image pick-up device of claim 69, wherein the coding means comprises a label which is adhered releasably to the housing.

71. The image pick-up device of claim 69, wherein the image storage means comprises a photographic film.

72. The image pick-up device of claim 69, wherein the image storage means comprises a digital storage means and the image pick-up device further comprises a digital image pick-up means for recording image information.

73. The image pick-up device of claim 69, wherein the database locator code is arranged on a packaging of the image pick-up device.

74. The image pick-up device of claim 73, wherein the image storage means comprises a digital storage means and the image pick-up device further comprises a digital image pick-up means for recording image information.

75. The image pick-up device of claim 73, wherein the image storage means comprises a photographic film.

76. The image pick-up device of claim 75, wherein the image storage means comprises a digital storage means and the image pick-up device further comprises a digital image pick-up means for recording image information.

77. A system for making available, via a wide area computer network, at least one image made by means of an image pick-up device, the system comprising:
(a) an image pick-up device having
(i) a housing;
(ii) an image storage means arranged in the housing for storing image data;
(iii) a database;
(iv) a first identification code for identifying the image storage means or the image within the database, said first identification code being associated with the image storage means; and
(v) a database locator code for locating the database on said computer network;
(b) at least one first computer that is connectable to said computer network for inputting the database locator code and viewing the image;
(c) at least one second computer that is connectable to said computer network having at least one database for storing the image and an image data transfer means for transferring image data into the database;
wherein the image is associated with the first code and the first code is the same as the database locator code or the second code is associated with the first code.

78. The system of claim 77, wherein the first code is a field in the database.

79. The system of claim 77, wherein the database locator code comprises an internet address.

80. The system of claim 77, wherein at least one part of the database locator code can be searched for in a field in the database.

81. The system of claim 77, wherein the database is accessible via an internet site.

82. The system of claim 81, wherein a person can download the image from the second computer to the first computer via the internet site.

83. The system of claim 81, wherein a person can order a photo print of the image via the internet site.

84. The system of claim 77, wherein a part of the first code comprises an internet address.

85. The system of claim 77, wherein the first code is associated with the housing.

86. The system of claim 85, wherein the first code is a field in the database.

87. The system of claim 85, wherein the database locator code comprises an internet address.

88. The system of claim 85, wherein at least one part of the database locator code can be searched for in a field in the database.

89. The system of claim 85, wherein the database is accessible via an internet site.

90. The system of claim 89, wherein a person can download the image from the second computer to the first computer via the internet site.

91. The system of the claim 89, wherein a person can order a photo print of the image via the internet site.

92. The system of claim 85, wherein a part of the first code comprises an internet address.

93. The system of claim 77, wherein the database locator code is arranged on a coding means.

94. The system of claim 93, wherein said coding means comprises a label which is adhered releasably to the housing.

95. The system of claim 93, wherein the first code is a field in the database.

96. The system of claim 93, wherein the database locator code comprises an internet address.

97. The system of claim 93, wherein at least one part of the database locator code can be searched for in a field in the database.

98. The system of claim 93, wherein the database is accessible via an internet site.

99. The system of claim 98, wherein a person can download the image from the second computer to the first computer via the internet site.

100. The system of claim 98, wherein a person can order a photo print of the image via the internet site.

101. The system of claim 93, wherein a part of the first code comprises an internet address.

102. The system of claim 77, wherein the database locator code is arranged on a packaging of the image pick-up device.

103. The system of claim 102, wherein the first code is a field in the database.

104. The system of claim 102, wherein the database locator code comprises an internet address.

105. The system of claim 102, wherein at least one part of the database locator code can be searched for in a field in the database.

106. The system of claim 102, wherein the database is accessible via an internet site.

107. The system of claim 106, wherein a person can download the image from the second computer to the first computer via the internet site.

108. The system of the claim 106, wherein a person can order a photo print of the image via the internet site.

109. The system of claim 102, wherein a part of the first code comprises an internet address.

110. The system of claim 77, wherein the image storage means comprises a photographic film.

111. The system of claim 110, wherein the first code is a field in the database.

112. The system of claim 110, wherein the database locator code comprises an internet address.

113. The system of claim 110, wherein at least one part of the database locator code can be searched for in a field in the database.

114. The system of claim 110, wherein the database is accessible via an internet site.

115. The system of claim 114, wherein a person can download the image from the second computer to the first computer via the internet site.

116. The system of claim 114, wherein a person can order a photo print of the image via the internet site.

117. The system of claim 110, wherein a part of the first code comprises an internet address.

118. The system of claim 77, wherein the image storage means comprises digital storage means and the image pick-up device further comprises a digital image pick-up means for recording image information.

119. The system of claim 118, wherein the first code is a field in the database.

120. The system of claim 118, wherein the database locator code comprises an internet address.

121. The system of claim 118, wherein at least one part of the database locator code can be searched for in a field in the database.

122. The system of claim 118, wherein the database is accessible via an internet site.

123. The system of claim 122, wherein a person can download the image from the second computer to the first computer via the internet site.

124. The system of claim 122, wherein a person can order a photo print of the image via the internet site.

125. The system of claim 118, wherein a part of the first code comprises an internet address.

126. The system of claim 77, wherein the first code is associated with the image storage means.

128. The system of claim 126, wherein the first code is a field in the database.

129. The system of claim 126, wherein the database locator code comprises an internet address.

130. The system of claim 126, wherein at least one part of the database locator code can be searched for in a field in the database.

131. The system of claim 130, wherein the database is accessible via an internet site.

132. The system of claim 130, wherein a person can download the image from the second computer to the first computer via the internet site.

133. The system of claim 130, wherein a person can order a photo print of the image via the internet site.

134. The system of claim 126, wherein a part of the first code comprises an internet address.

135. A method for distributing at least one image, comprising the steps of:
(a) recording image data in image storage means of an image pick-up device for once-only use, said image data being associated with a first identification code for identifying the image storage means or the image within a database, said first identification code being associated with the image storage means;
(b) removing or taking over a database locator code from the housing of said image pick-up device;
(c) transferring the image data via a wide area computer network from the image storage means to a database together with the first identification code with which the image data are associated; and
(d) making a connection to the database using a computer and the wide area computer network and retrieving the image data on the basis of the database locator code;
wherein the image is associated with the first code and the first code is the same as the second code or the database locator code is associated with the first code.

136. The method of claim 134, further comprising one or more of the steps of:
(a) selecting a desired image;
(b) printing the selected desired image; and
(c) sending the printed selected desired image.
